(19) United States
(12) Patent Application Publication
(10) Pub. No.: US 2025/0285651 A1
(43) Pub. Date: Sep. 11, 2025

(54) Systems and Methods of Representing Digital Video with Threads

(71) Applicant: Encant AI, Inc., Los Angeles, CA (US)

(72) Inventors: Christopher Scott Dacko, Los Angeles, CA (US); Randy Culley, Dayton, NV (US)

(21) Appl. No.: 19/076,621

(22) Filed: Mar. 11, 2025

Related U.S. Application Data
(60) Provisional application No. 63/563,797, filed on Mar. 11, 2024.

(51) Int. Cl. G11B 27/34; H04N 19/42; H04N 19/60

(52) U.S. Cl. CPC G11B 27/34; H04N 19/42; H04N 19/60

(57) ABSTRACT

In some aspects, a method is described. The method can include receiving frame-based video comprising a series of frames, encoding the frame-based video into threaded video, and storing the thread based data in a memory device, where the threaded video is sparser than the frame-based video. Encoding the frame-based video into threaded video can include converting the frame-based video into a domain space, and generating a set of tiles, each tile of the set of tiles corresponding to a sub-space within the series of frames. The method can include generating a set of control points while traversing a driving parameter of the series of frames based on a delta.

### CROSS-REFERENCES TO RELATED APPLICATIONS

This application claims priority to U.S. Provisional Patent Application No. 63/563,797, filed on Mar. 11, 2024, and entitled “SYSTEM AND METHOD OF REPRESENTING DIGITAL VIDEO WITH THREADS,” the disclosure of which is hereby incorporated by reference in its entirety.

### TECHNICAL FIELD

The present disclosure relates generally to digital video, and specifically to a system and methodology for encoding and decoding spectral signal data using mathematical constructs (cubic curves, splines, high order surfaces, etc.). More specifically, but not by way of limitation, this disclosure relates to systems and methods representing digital video with threads.

### BACKGROUND

Conventional video processing techniques are designed for frame-based video. Frame-based video comprises a sequence of 2-D images used to store digital video data. Processing and storage of frame-based video data can contribute to significant volumes of data when data values must be captured for each pixel of each frame of a given video. Because traditional frame-based video requires significant amounts of data which must be stored, and in some cases transmitted, memory storage devices and networks are both burdened by the large volumes of data. With respect to memory devices, frame-based video encodings may take up a significant amount of space, limiting the storage of other data, or requiring the expansion into larger memory devices. Similarly, transmitting frame-based video over a network can lead to latency over the network or losses in transmission due to frame-based video data exceeding the network limitations. In each case, frame-based video's data footprint imposes burdens on the hardware capabilities within computing systems.

### SUMMARY

Various embodiments of the present disclosure provide techniques for representing digital video as threads, which are constructs built on a pixel or tile basis over time. This threaded video, as opposed to frame-based video, provides novel compression and functionality not previously possible with frame-based video systems. The techniques described herein involve receiving frame-based video source data including a series of frames, and encoding the frame-based video source data into threaded video through a set of encoding operations. The encoding operations can include converting the frame-based video source data into a domain space, and generating a set of tiles, each tile of the set of tiles corresponding to a sub-space within the series of frames. For each tile of the set of tiles, the encoding operations can include generating a set of control points while traversing a driving parameter of the series of frames based on a delta. Threaded video files can be stored in a memory device. The threaded video is sparser than the frame-based video source data. “Threads,” as used herein, are mathematical constructs which can extrapolate and approximate continuous values (such as lines, curves, and the like) from sets of control points corresponding to a given tile over time. The thread can allow for the reconstruction of tile values such as color values or luminance values when outputted via a playback device. Threaded video refers to the storage of control points and any additional data used to construct the threads. The techniques can be embodied as computer-implemented methods, non-transitory computer-readable storage media storing program code executable by a processing device to perform the described operations, and computer systems programmed to perform such operations.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim. The foregoing, together with other features and examples, will become more apparent upon referring to the following specification, claims, and accompanying drawings.

### BRIEF DESCRIPTION OF THE DRAWINGS

FIG. 1 is a block diagram depicting an example system architecture and process flow for encoding and decoding threaded video, according to certain aspects of the present disclosure.

FIG. 2 is a block diagram depicting an example methodology for encoding threaded video from frame-based sources, according to certain aspects of the present disclosure.

FIG. 3 shows an expanded image buffer according to certain aspects of the present disclosure.

FIG. 4 shows an illustration of control points in color space used to generate a thread, according to certain aspects of the present disclosure.

FIG. 5. illustrates a differential application of control points to the same video data, according to certain aspects of the present disclosure.

FIG. 6 shows threaded video file architecture, according to certain aspects of the present disclosure.

FIG. 7 shows an example set of operations for decoding threaded for variable playback on various devices, according to certain aspects of the present disclosure.

FIG. 8 shows operations for generating threaded video per decoder for variable playback on various devices, according to certain aspects of the present disclosure.

FIG. 9 shows a block diagram depicting an example of a computing device, which can be used to implement encoding operations and/or decoding operations according to certain aspects of the present disclosure.

### DETAILED DESCRIPTION

Traditional video encoding approaches rely on representing video on a frame-by-frame basis, usually premised on capturing pixel values (e.g., color, luminance, and the like) at each frame of a video. Recording the value of each pixel at each frame can be used to ensure high fidelity of output upon decoding the frame-based encoding. However, frame-based encodings can easily produce significant amounts of data given that pixel values at each frame must be stored in some form of file structure. Moreover, much of the data within frame-based encodings is temporally redundant because pixel values between frames within a video often remain static, or vary only slightly between frames.

Control points are mathematical constructs used to define the shape of lines, curves, surfaces and other higher-dimensional objects. The generated curve or other approximation may then be used to extrapolate values along the curve. A set of control points may be used to define the geometry of a curve using a sparser set of data compared to more continuous techniques for mapping data. For instance, previous video encoding techniques using frame-based video have relied on the generation of data points for each pixel at each frame. Such encoding techniques result in larger amounts of data and less sparsity within frame-based files. Thus, by encoding video data such as pixel color, luminosity, and the like, through a set of control points, where the control points are temporally arranged across multiple sequences of frames, fewer data points are required to reconstruct or calculate pixel values of any given frame.

Previous video encoding techniques have considered the implementation of control points and curves to compress video data including pixel values into lower-profile data, as compared to the frame-based encoding approach. Splines, for instance, are capable of representing large sets of data (e.g., pixel values at a given frame) with a set of control points, where the set of control points requires fewer data points for storage than frame-based storage. For instance, as opposed to storing pixel values at each frame for a given pixel, a fewer number of control points than frames may be used to reconstruct the pixel values at each frame. However, the generation of curve representations of video data can still lead to large sets of data. Previous techniques for curvature, spline, and control point compression of video data have relied on pixel-level approaches and avoided tile-based approaches due to creation of blocking artifacts, and further on, generating control points at fixed, constant time intervals or in response to error between original and fitted data. Such techniques continue to produce large sets of data inadequate for various video applications such as live-streaming interfaces, while also failing to conserve sufficient memory on local devices. Such prior techniques have favored pixel-level approaches, and fixed spatial sampling of control points on the presumption that such techniques are necessary to preserve fidelity upon decoding the compressed data. Moreover, prior techniques were limited to analyzing changes in luminosity only. These prior techniques are thus unable to generate more robust curve approximations and control points via analyzing frame data across multiple domains, and via analyzing frame data over time.

Certain aspects and features of the present disclosure address issues related to improved techniques for encoding and decoding video and other frame-based data using threads (e.g., cubic curves, splines, high order surfaces, and the like). The threads can be exploited to approximate and extrapolate spectral signal data from frame-based video by using a reduced data set, providing improvements in local data storage in addition to transmission of data requiring less bandwidth. The generated “threaded video” provides novel compression and functionality, not previously possible with frame-based video systems.

To achieve the described improvements, the invention relies on a specially designed video encoder and decoder. A video encoder is a hardware device or software application that converts an analog or digital video signal into a compressed digital format, reducing the file size of a video by using compression algorithms to make it easier to store and/or transmit. A video decoder is a hardware device or software application that performs the reverse function of a video encoder—it takes encoded (compressed) video data and converts it back into a format that can be played, displayed, or processed. Decoders are essential for video playback, as they make it possible to view compressed video files on various devices and platforms.

Each of the encoder and decoder according to various embodiments may be provided in the form of software code and/or hardware. In some examples, each of the encoder and decoder comprise software instructions that can be executed on any capable processor-driven computing device(s) to perform the functions described herein. The encoder and decoder can be implemented on the same or separate hardware devices.

The encoder can receive frame-based video, for instance from local memory or from transmission from another source. The encoder subsequently can perform a set of operations to generate threaded video files which can be decoded by the decoder. The encoder operations can generally include analyzing various spectra of each frame within the frame-based video. The spectra can be analyzed according to various domain spaces including color space, luminance space, frequency space, or any other domain capable of characterizing pixel values in each frame. The encoder operations can include analyzing the domain spaces on a per tile per frame basis, where a tile refers to a space defined by a collection of one or more pixels within a frame. The tile, representing a sub-space of a frame, may be fixed across a sequence of frames. Thus, reference to tiles generally refers to a sub-space of a frame or a series of frames. In other examples, tiles can change shape between frames. In some examples, encoding can be evaluated on a per pixel per frame basis (i.e., where each tile comprises a single pixel as opposed to a set of pixels). Analyzing the domain space includes evaluating tile values at each frame, and generating control points dependent on threshold changes for each tile between frames. Each tile, representing a sub-space of a given series of frames, can thus lead to different sets of control points generated while traversing the series of frames.

In an example, a scene in a video may be dimly lit where each of the four corners of the scene are uniformly dark while the center region of the scene changes more rapidly between frames due to changes in lighting. As a result, tiles located closer towards each corner of each frame in the series of frames will change less frequently compared to tiles located more centrally within each frame in the series of frames. For the set of tiles within the dimly lit scene, the corner adjacent tiles will require fewer control points to recreate the scene compared to the more central tiles because the corner frames' relative consistency in luminance or color values over the series of frames. Once generated, the full set of control points may be stored as a threaded video file. Because the threaded video is encoded into sets of control points, instead of being encoded into pixel values at each frame, the threaded video file will be inherently sparser than the frame-based video. Additional compression techniques including deduplication may also be included to provide further benefits in data reduction.

The decoder can receive the threaded video file from a local disk or across a network. The threaded video file, including sets of control points corresponding to each tile or pixel, can be used to reconstruct the frame-based video on a playback device through generation of threads. The threads can reconstruct pixel values at each frame, based on approximating and extrapolating connections between control points. Because threads can be continuous values, the only limits to reconstruction would be playback requirements of a given device or as set by a user. The decoder can determine playback requirements based on limitations of the playback device, and/or can have configurable playback requirement instructions received via a user interface.

Multiple user interfaces may be implemented according to various embodiments to configure decoupled encoding and decoding settings. For instance, in some examples, a front end-user interface can control encoding settings such as maximum tile sizes and the rate at which control points are generated, while in a receiving end user interface, users may configure frame rate output, or cause signals to be transmitted back to the encoder.

Certain aspects described herein overcome the limitations of previous techniques for compressing frame-based data such as video data. Frame-based encoding techniques rely on storing pixel values at each frame over full series of two-dimensional frames within video data resulting in generation and required storage of significant amounts of data. In contrast, the described techniques relate to storing control points, which are inherently sparser data formats. The control points, used to reproduce video through thread approximations, can significantly increase compression without sacrificing fidelity.

Moreover, compared to prior techniques for video compression via control point generation, the described techniques provide further improvements in data compression, contributing to technical improvements in storage and network transmission of encoded data. While previous techniques have approached control point compression on a pixel basis, the described techniques include compression on a tile basis, where each tile includes a collection of pixels. Control point compression on a tile basis can lead to significant increases in data compression capabilities achieved by the described encoder. Further, previous control point encoding approaches have relied on generating control points according to more static methods. Specifically, prior techniques for control point compression have generated control points at fixed intervals (e.g., a control point at every 10 frames) or fixed thresholds. The techniques described here provide more fluid control point generation techniques to improve data sparsity. For instance, techniques for increasing sparsity of control point datasets are described which can generate control points according to various differentials such as rates of change between control points, and accelerations in changes between control points.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Example Overview of Process for Encoding and Decoding Threaded Video

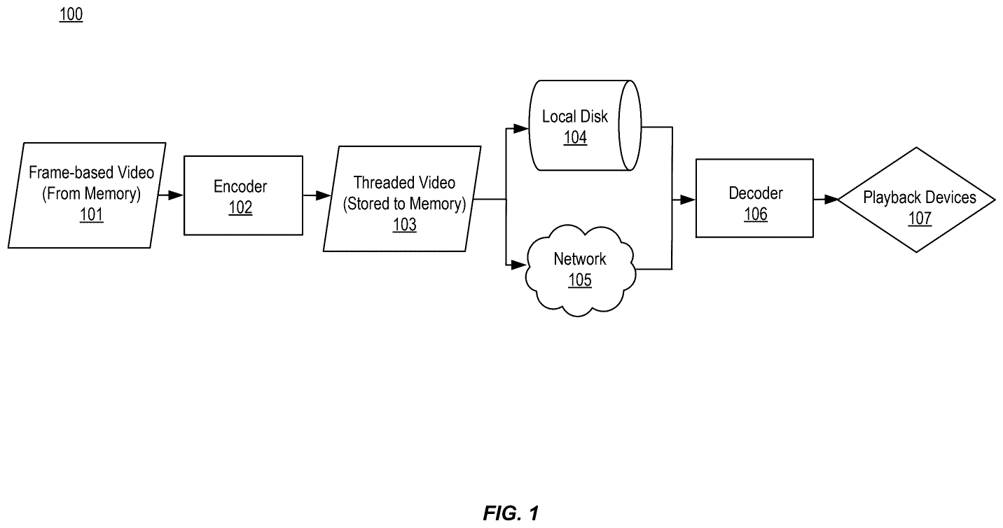

Referring now to the drawings, FIG. 1 is a block diagram depicting an example system architecture and process flow for encoding and decoding threaded video, according to certain aspects of the present disclosure. Blocks 101 through 107 show an example flow for encoding and decoding video, though it is to be appreciated that the illustration is a logical and not physical representation. According to various examples, one or more operations can be performed on the same or different physical devices.

Block diagram 100 is shown to represent frame-based video 101, which may be retrieved from a memory storage device (e.g., a buffer, a local disk 104) or received from another device via the network 105. The frame-based video 101 can include data structures encoded according to traditional frame-based encoding data structures, for instance, color space values including RGB, YCbCrGr values and the like, for each pixel within each frame. Frame-based video can include pre-recorded video data and live-stream video data and any other frame-based source files where image data is captured over a series of frames.

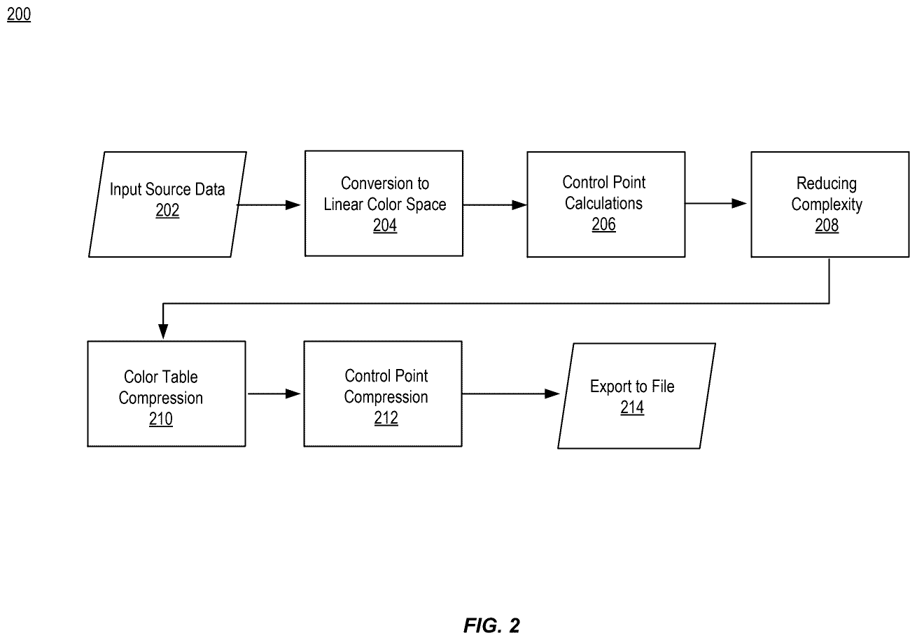

The frame-based video is shown loaded into an encoder 102. The encoder includes programmable logic and executable instructions for converting the frame-based video into threaded video 103 which may be stored in one or more memory devices including various buffers. The threaded video 103, as encoded per encoder 102 can be sparser than the frame-based video 101. Additional techniques related to the operations of encoder 102 are discussed with respect to FIG. 2.

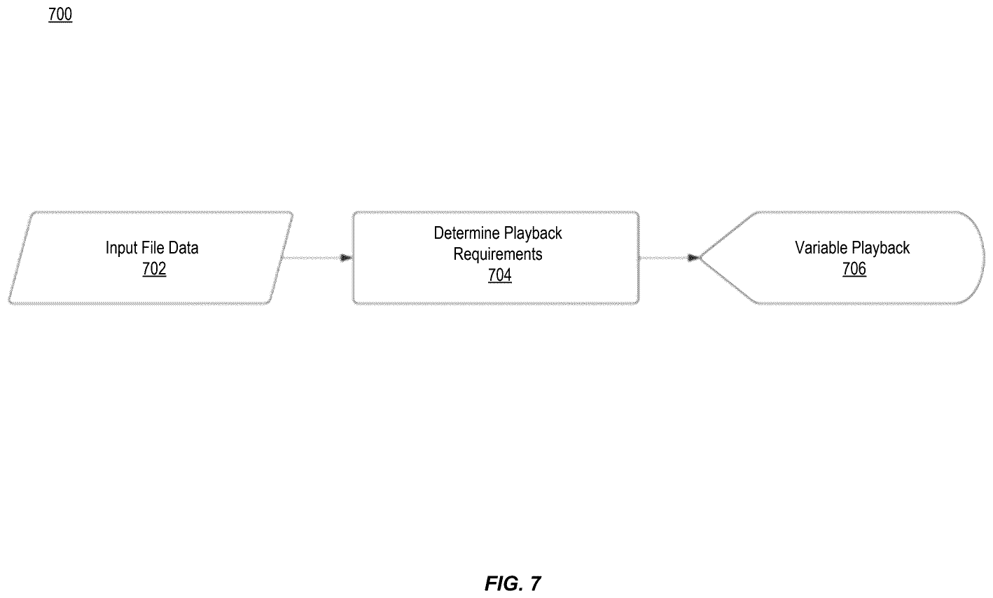

The threaded video 103 can be saved locally to a local disk 104, or caused to be transmitted over a network 105. The threaded video 103 can be loaded locally from the local disk 104 or received by the decoder 106 via the network 105. Once loaded or received, the decoder 106 can convert the threaded video 103 into any number of formats for playback on different playback devices 107. The decoder 106 can include programmable logic and executable instructions for decoding the threaded video file 103 into any number of formats for playback on different playback devices 107. For instance, the decoder 106 can monitor and determine playback device requirements to determine playback parameters and corresponding decoding instructions. Similarly, user input received via the playback device 107 or other device can configure the playback parameters and corresponding decoding instructions. Additional techniques related to the operations of decoder 106 are discussed with respect to FIG. 7.

Playback device 107 can have any visual interface capable of receiving decoded video data (i.e., conventional frame-based video data structures) and/or encoded, threaded video which the playback device 107 can subsequently decode per decoder 106 operations. In some examples, such as those discussed according to FIG. 7, the decoder 106 can communicate with the visual interface to determine the playback requirements of the playback device 107. Playback requirements can include parameters such as available frames per second, color values, output resolution determined according to the playback device 107 hardware. Playback device 107 includes hardware capable of outputting video data generated by the visual interface and decoder 106. Playback devices 107 can include, for instance, computer interfaces, mobile devices, televisions, projectors, and the like. In an example case, playback devices 107 can display decoded pre-recorded frame-based video, or real-time or near-real time recorded video frames in the form of livestream video.

### Example Operations for Encoding Threaded Video

FIG. 2 is a block diagram depicting an example methodology for encoding threaded video from frame-based sources, according to certain aspects of the present disclosure. For illustrative purposes, the encoder operations 200 are described with reference to implementations described above with respect to one or more examples described herein. Other implementations, however, are possible. In some aspects, the operations in FIG. 2 may be implemented in program code that is executed by one or more computing devices. In some aspects of the present disclosure, one or more operations shown in FIG. 2 may be omitted or performed in a different order. Similarly, additional operations not shown in FIG. 2 may be performed.

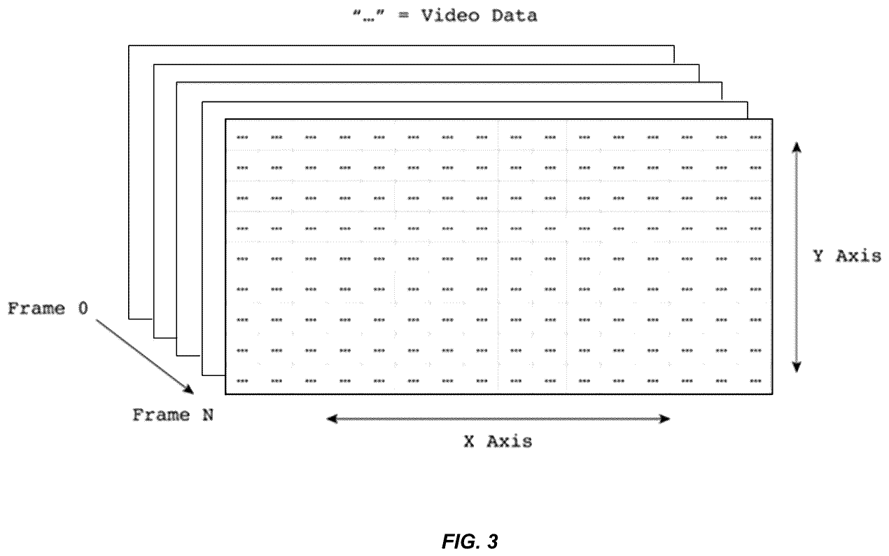

At block 202, the encoder operations 200 include receiving input source data. Input source data can include the frame-based video, which may be retrieved from a memory storage as described with respect to block 101 of block diagram 100. The input source data, including the frame-based video, can be expanded by the encoder 102 into a fully-expanded image buffer, shown according to FIG. 3.

FIG. 3 shows a representation of an expanded image buffer 300 according to certain aspects of the present disclosure. The expanded image buffer 300 is shown containing video data from Frame 0 to Frame N, where N can be any number up to the last frame of the source video. The video data can include meta-data containing information about the length of the source video, the offset to each frame in the image buffer 300, and the frame time relative to the original video time for each frame. The data arranged from Frame 0 to N is shown arranged sequentially across the time domain. It is to be appreciated that the data can be arranged sequentially across any domain, where such domains are referred to as driving parameters for providing sequential arrangements of frames.

Video data at each pixel can include single or multi-dimensional data structures describing pixel values such as 3-D arrays for color values (e.g., RGB), one dimensional values such as luminance, and any other array data structure describing characteristics of the corresponding pixel.

Returning to the example of FIG. 2, at block 204, the operations include converting the input source data to linear color space. The encoder 102 can convert sensor data in the image buffer to linear color space. The conversion to linear color space allows for subsequent control point analysis. Linear color space provides useful metrics for evaluating changes in color data, and provides advantages over luminance-only techniques, particularly with respect to full-color high-resolution video. Linear color spaces can include any variety of RGB colors (e.g., Rec. 2020, Rec. 709, sRGB, and the like), in addition to other color spaces such as uniform color spaces. While reference is made to linear color space, it is to be appreciated that other spaces may be used such as nonlinear color spaces (e.g., Y′UV), in addition to non-color spaces (e.g., hue, saturation and value “HSV”), luma, blue-difference chroma, red-difference chroma (“YcbCr”), linear distance, luminance, variance per color channel, and the like.

At block 206, the encoder operations 200 include performing control point calculations. The control point calculations per block 206 can occur on a per pixel basis or on a per set of pixels basis (referred to as “tiles). For example, the encoder 102 operations, including its compression algorithm, is applicable to pixel tiles of any size (2×1, 2×2, 4×4, 40×40, etc.). While the tile dimensions may be arbitrary, in preferred examples, the tile dimensions may be square or rectangular. Moreover, while discussion at per block 206 and encoder operations 200 more generally refer to a pixel-level approach, it is to be appreciated the approach similarly applies to a tile-level approach where generation of control points correspond to tile-sized collections of pixels. Thus, while reference below may be made to pixel-level control point generation, similar approaches may be applied on a tile-basis where each tile includes one or multiple pixels.

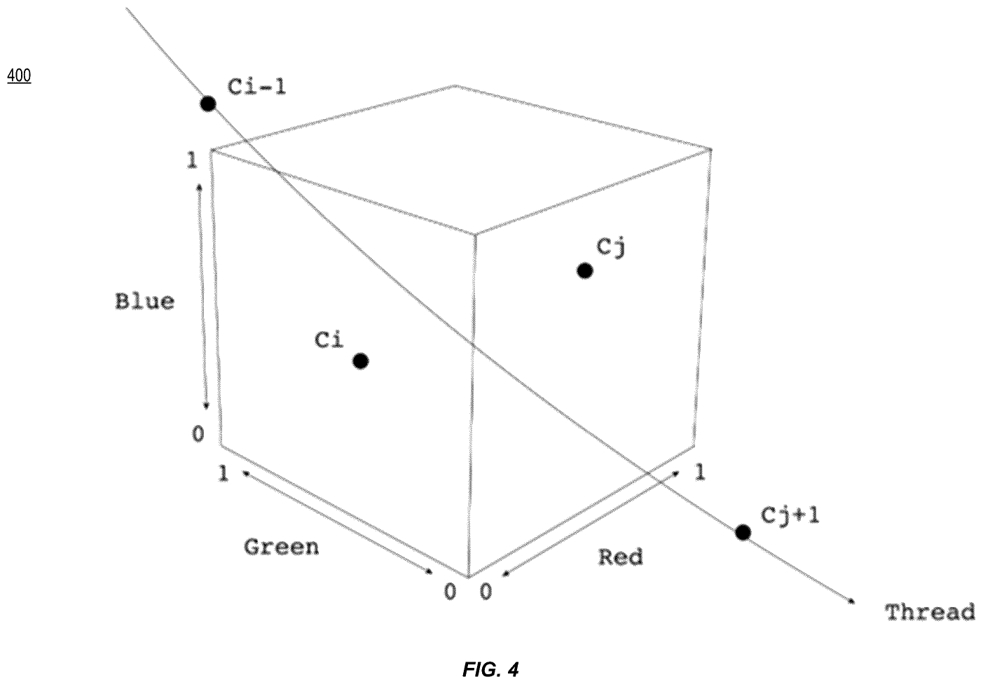

For each pixel (denoted with x,y coordinates per FIG. 4) in a given frame (referred to as Frame A) within the range of Frame 0 and Frame N, the encoder 102 composes a control point comparing Frame A to a previous control point P, calculated as relevant to constructing the cubic curve used to determine the pixel value between control point A and control point A-p using a parametric value relative to the parametric driver (e.g., a parametric value t relative a to a total duration of frame-based video).

Control points may be used to construct a cubic spline or other thread based on an extrapolation of the control points, such as a Catmull-Rom curve, Quadratic Bezier curve, linear interpolation, or the like. In preferred examples, each thread comprises a curve such as a Catmull-Rom curve which may provide a more accurate representation of color values and for greater sparseness than linear interpolation.

FIG. 4 shows an illustration of control points in color space used to generate a thread, according to certain aspects of the present disclosure. The illustration 400 includes two pairs of control points defined by Ci with C(i−1), and Cj with C(j+1). For each pair of control points, a first control point is shown, followed by the same control point displaced by the driving parameter (e.g., time). For instance, control point pair C(i−1) and Ci are shown referring to the same control point displaced in time. Control points Cj and C(j+1) are similarly shown to illustrate the trajectory of control point Cj displaced in time. For each set of control points Ci, C(i−1) and Cj, C(j+1), the curve (or thread more generally) will need to use control points C(i−1) and Ci to evaluate the curve accurately between Ci and Cj.

The nature of parametric mathematical constructs can vary the number of control points necessary to generate the thread. For instance, the example of FIG. 4 relates to a Catmull-Rom curve, using a normalized value for the parametric driver. Setting a parametric driver (t) to 0.0 will evaluate to intersection Ci, while (t) equal to 1.0 will evaluate to Cj, while further providing continuity with preceding and following control points in the curve. In the example of FIG. 4, the control points are conceptualized in a local color space cube chained together for evaluation as cubic curves using normalized time as the driving parameter for the local curve components {C(i−1) through C(j+1)}. It is to be appreciated that alternative domain spaces can be used such as alternative color spaces which can be used to improve sparseness while maintaining sufficient data to reconstruct each frame of the multi-frame video.

Returning to FIG. 2, at block 208, the encoder operations 200 include reducing complexity of the control point data. Because control points are generated in response to identified differentials of pixel values between frames, the operations at block 206 contribute to a first level of improved data sparsity. Moreover, the control point generation techniques will generally contribute to variable control point density along the time domain. The operations of blocks 208-212 can contribute to further improvements in data sparsity by performing data deduplication on the sets of control points to reduce control point density. For example, per block 208, data deduplication can include generation of sparse data per pixel along the time axis, by comparing and eliminating values that are not essential to the reconstruction of pixels or tiles when evaluating the curve/thread as a parametric equation evaluated for (t). Non-essential values can be determined by comparing the value against a threshold relative to the domain, color space being used.

The threshold comparison to reduce complexity can be determined according to a number of different methods, including, but not limited to, calculating changes in luminance, YCbCr values, HSV values, linear color space distances, and equalities between the current and previous control points along the curve. Additionally, user provided (or programmatically determined) inputs determine if the delta between a previous control point and the current pixel value warrant storage of the current pixel as a control point. The delta for instance can be compared against a configurable threshold to determine whether to keep or remove a given control point.

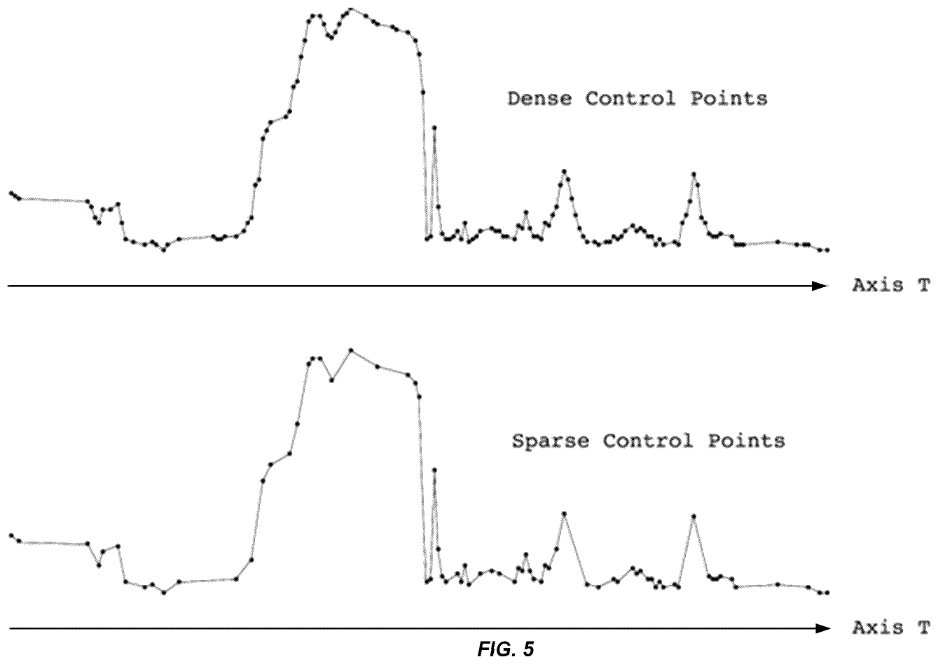

FIG. 5. illustrates a differential application of control points to the same video data, according to certain aspects of the present disclosure. According to FIG. 5, the same video data (e.g., values for a given tile captured over a period of time) is shown in a top chart and a bottom chart, where the top chart shows a denser set of control points generated to represent the video data compared to the bottom chart, instead showing a sparser set of control points. Compression increases with the sparsity of control points. The level of sparsity can be controlled by configuring how control points are generated. For instance, a delta, or differential threshold can generate control points when the tile value at the previous control point differs from the tile value at a current frame by a certain percentage. By increasing the delta, the number of control points can be reduced, as shown in the top and bottom charts of FIG. 5. The level of sparsity can also be controlled after an initial set of control points are generated by performing data deduplication and further compression techniques on the threads which reconstruct continuous curves based on the control points. For example, derivative values of curves connecting control points, reflecting change in the slope of the thread, can be used to determine which control points to remove. The slope of a thread (i.e., curve) can be compared against a threshold, and in response to exceeding the threshold, a sparser set of control points can be generated. According to further examples, the second derivative of curves connecting control points may be used to determine the removal of control points, providing further compression of the control point data. Moreover, greater sparsity can be correlated to the size of the pixel tile, for instance, with 2×2 tiles providing four times compression of single pixel tiles, and 4×4 tiles providing sixteen times the compression of single pixel tiles, and so forth.

Returning to FIG. 2, at blocks 210 and 212, the encoder operations 200 include color table compression and control point compression, respectively. Various compression libraries and techniques may be called to perform color table and control point compression. For instance, Lempel-Ziv-Welch (“LZW″) compression, or various .ZIP compression algorithms may be used. Color table compression can be achieved by instancing colors in a color table with control points storing an index to the relevant color and time (t) for the given control point for evaluation during playback. More generally, compression tables can be generated for any domain space used, including various color tables, luminance tables, wavelets, and the like. Additional compression can be achieved by instancing control points into a table requiring reduced data storage for image reconstruction. Data stored within a control point table can be further reduced based on the length of the original video and precision needed to represent that length in seconds (or other metrics). According to some examples, the compression techniques applied to compress the color table are applied separately from the compression techniques applied to the control point data.

Such compression techniques per blocks 210 and 212 are optional and may be applied in various, but not necessarily all described examples. For instance, such compression operations may be applied prior to storage of thread video on local disks (e.g., local disk 104 per FIG. 1), while not being performed within livestreaming applications when threaded video is transmitted over a network (e.g. 105 per FIG. 1) so as to avoid increased latency in data transmission.

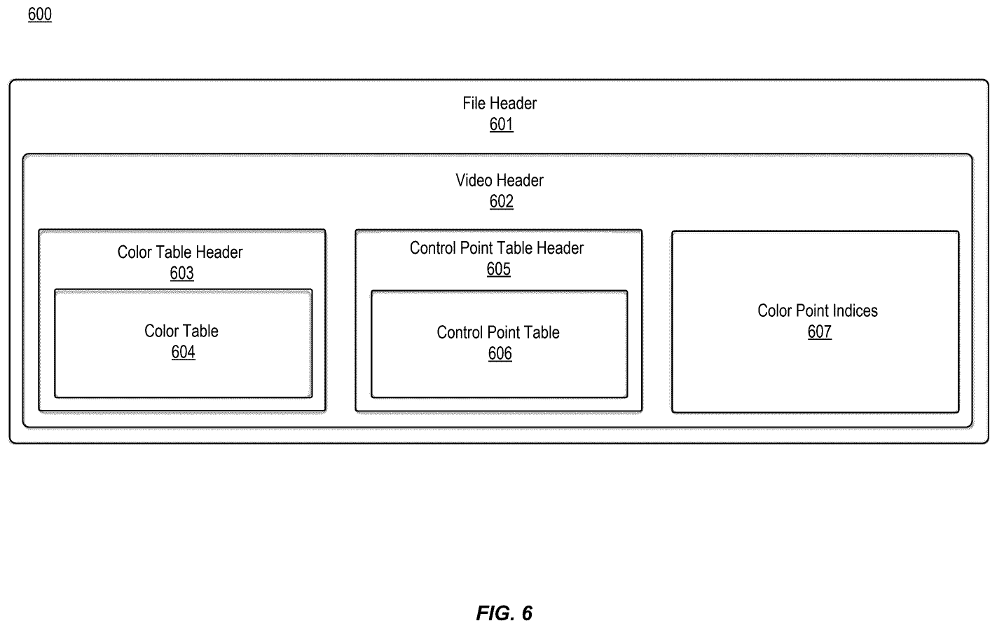

At block 214, the encoder operations 200 include exporting the compressed data to a file. FIG. 6 shows threaded video file architecture, according to certain aspects of the present disclosure. Final color storage can be stored in linear color space at any desired bit depths, for example 8:8;8: (R:G:B:) or 10:12:10 (R:G:B), so as to provide transformation into Standard Dynamic Range (“SDR”), High Dynamic Range (“HDR”), and alternative color spaces for final display.

According to the example of FIG. 6, the threaded video file architecture 600 is shown to include a file header 601 wrapping a video header 602. The video header 602 is shown wrapping (i) a data structure including a color table header 603 and associated color table data 604; (ii) a data structure including a control point table header 605 and associated color point table 606 data; and (iii) color point indices defining the threads (e.g., curves) along the (x), (y), and (t) axes. According to other examples, more or fewer data structures may be included within the file header 601. The color table 604, control point table 606, and color point indices 607 are shown as separate data structures, according to the example of FIG. 6. In such examples, separate compression operations can be performed on each tables and indices 604, 606, and 607. For instance, compressing control point data can occur in a table separate from the indices that control the control point coordinates in the domain space. Similarly, compressing color data can occur in a table separate from the indices that control the control point coordinates in the domain space.

Following the export to file per block 214, the encoder 102 will have completed the encoder operations 200 described according to the example of FIG. 2. As discussed with respect to FIG. 1, the now encoded, exported threaded video file 103 can be subsequently stored to a local disk 104, or transmitted over a network 105. Per the encoder operations 200, the threaded video file 103 is sparser than the frame-based video data retrieved from memory per block 101. Thus, the encoding operations provide improved techniques for storing data which can improve storage capabilities on local disks 104 in addition to reducing the size of data transmissions over a network 105 as described according to the additional operations of block diagram 100.

### Example Operations for Decoding Threaded Video

According to the operations discussed with respect to FIG. 1, additional procedures are described for decoding previously encoded threaded video file 103. FIG. 7 shows an example set of operations for decoding threaded for variable playback on various devices, according to certain aspects of the present disclosure. The described decoding operations 700 may be implemented via the decoder 106 as described with respect to FIG. 1. The decoder 106 may be configured to run in various operating systems and operating environments, each of which may include different versions of the decoder 106 optimized to meet the requirements of the respective operating system and/or environment. Thus, for illustrative purposes, the decoder operations 700 are described with reference to implementations described above with respect to one or more examples described herein. Other implementations, however, are possible. In some aspects of the present disclosure, one or more operations shown in FIG. 7 may be omitted or performed in a different order. Similarly, additional operations not shown in FIG. 7 may be performed.

At block 702, input file data is received. The input file data can include an encoded, threaded video file (e.g., having the threaded video file architecture of FIG. 6). The input data file can be received from a local disk 104 for processing by the decoder 106. Alternatively, the input file data can be received via download from a network source (e.g., network 105). Network sources can include other computing environments, cloud architectures, streaming services, and the like. Once downloaded, the input file data received via the network 105 can be similarly processed by the decoder 106.

At block 704, the decoder determines playback requirements. In some examples, the playback requirements can be based on, or based in part on, the output requirements of the playback device 107. For instance, playback requirements can be determined programmatically by the decoder 106 through scanning the computing capabilities of the playback device 107. Scanning the computing capabilities of the playback device 107 can include the decoder 106 communicating with the playback device 107 to determine metrics describing the computing and display capabilities of the playback device 107 hardware. The decoder 106 can retrieve, for instance, device metrics related to a central processing unit (“CPU”), graphics processing unit (“GPU”), random access memory (“RAM”) and virtual RAM, screen resolution, available frame rate ranges among other playback device 107 metrics. Additionally or alternatively, the playback requirements can be determined by user-defined inputs, for instance via a user interface on the playback device or 107 or other device communicatively coupled to the decoder 106. Playback requirements can include, for instance, the total length of the video to be played, measured in seconds, milliseconds, or other unit of time; the required output resolution of the instance in which the video is to be played; the required frame rate of the instance in which the video is to be played; the required output display color space of the instance in which the video is to be played; and the filtering requirements determined by other playback requirements which may be necessary to ensure high visual quality and smooth playback.

At block 706, the decoder determines variable playback parameters. Variable playback parameters can include several aspects which may be directly controlled by the decoder 106. Variable playback parameters can include setting playback speed as a scalar of time relative to the original source. Playback speed can further be determined at the moment of playback, or during playback, where the playback speed can be a function of the processing power of the playback device 107. Image reconstruction can be derived from the evaluation of the thread (e.g., a Catmull-Rom curve thread), based on time, (t). Time (t) can also be scaled relative to the original source length (e.g., of frame-based video 101), or by any user- or programmatically-defined value (e.g., 12, 24, 60, 120, 1000 frames per second).

Additionally or alternatively, variable playback parameters can include adjustments to color output. For instance, the color space for final output can be similarly determined at the moment of playback such that different playback devices 107, requiring distinct color spaces can be supported by a single threaded video file 103. Image filtering on pixels or tiles can be controlled by player input, e.g., through a user interface, and similarly be adjusted during playback. In such examples, smoothing, color correction, and additional purposes can be served via decoder operations 700.

### Example Operations for Generating Threaded Video

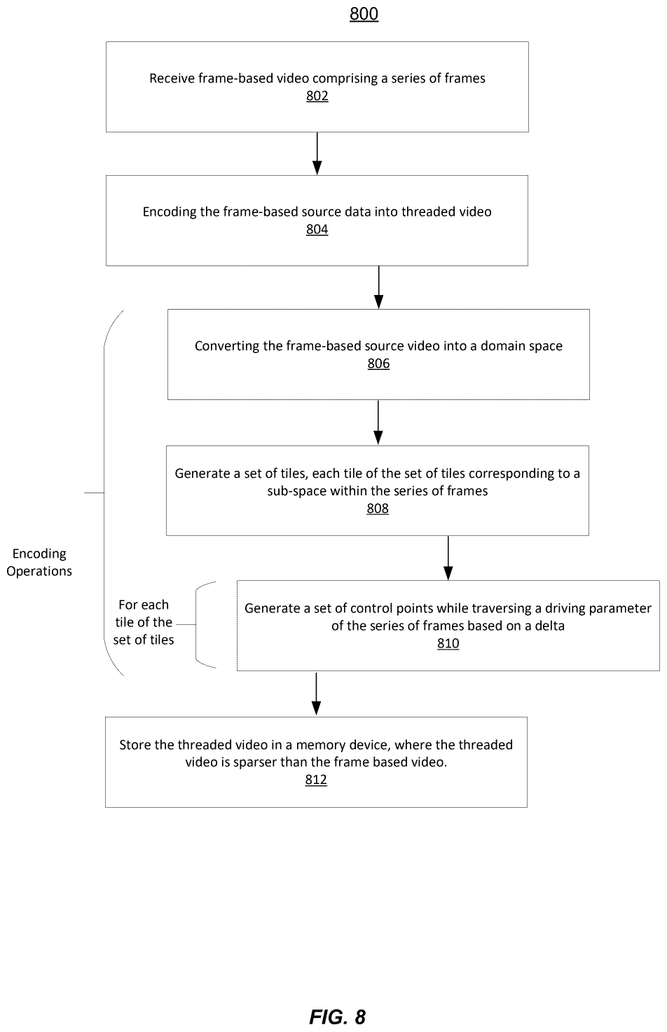

According to the operations discussed with respect to FIGS. 1-7, threaded video may be generated and output via various playback devices. FIG. 8 shows operations for generating threaded video per decoder for variable playback on various devices, according to certain aspects of the present disclosure. Other implementations, however, are possible. In some aspects of the present disclosure, one or more operations shown in FIG. 8 may be omitted or performed in a different order. Similarly, additional operations not shown in FIG. 8 may be performed.

At block 802, the operations 800 include receiving frame-based video comprising a series of frames (e.g., video data). The frame-based video can be retrieved from a memory device similar to block 101 of block diagram 100. Frame-based video can include pre-recorded video data, live-stream video data, or any other form of data comprising a series of two or more image frames.

At block 804, the operations 800 include encoding the frame-based video into threaded video (also referred to generally as threaded video data or threaded video files). Specific examples of operations for encoding the frame-based video are described according to blocks 806-812, in addition to the description of encoder operations per FIGS. 2-6. Generally, threaded video can include control point data, where the control point data can be used to form various threaded formats of video data across a given domain. For instance, such threads can be linear (i.e., where control points are edges to line segments), or alternatively, can be curvature and spline threads such as Catmull-ROM curves. The storage of the control points in of itself can greatly reduce storage overhead for image data including pixel values.

At block 806, the operations 800 include converting the frame-based video into a domain space. For example, per block 204, the conversion can include conversion to linear color space, where linear color space can correspond to various color and luminance values for given pixels within a frame (e.g., HSV, YcbCr, and the like). Additionally, the domain space can refer to frequency domain space, achieved via wavelet transformations and other techniques.

At block 808, the operations 800 include generating a set of tiles, each where each tile of the set of tiles corresponds to a sub-space within the series of frames. As discussed with respect to FIG. 2, each tile of the set of tiles can include an arrangement of one or more pixels. For instance, each tile can refer to a single pixel, or can refer to a 2×1, 2×2, 2×4, or any other arbitrary grouping of pixels. Generally increasing the size of the tile can be used to reduce the number of control points and threads necessary to generate encoded, threaded video. Thus, according to some examples, the tile size may be a configurable value in generating the threaded video encodings.

Configuring the tile size for each set of tiles can include receiving, through a user interface, input determining the fidelity and/or processing speed requirements for encoding the frame-based video into threaded video. A front-end user may define an encoding speed, specified fidelity, maximum file size or other performance setting, and in response, the encoder 102 can adjust the maximum size of the tiles which are generated. Thus, front-end users, such as those controlling the storage or transmission of the threaded video can configure encoding settings prior to the transmission of threaded video. In the same or other examples, receiving users, those who are receiving the transmitted threaded video data from across the network can similarly configure the playback settings of the threaded video as discussed above with respect to configuring variable playback settings. In further examples, tile sizes can be automatically determined based on computing requirements of downstream components such as the local disk 104 or network 105. For instance, in response to the encoder 102 detecting the bandwidth of the network 105 is under a set threshold, the encoder 102 can adjust the maximum tile size. Similarly, the encoder 102 may configure tile sizes to match storage capabilities of the local disk 104, for instance, in the absence or in response to user-configured settings. In some examples, different sets of tiles can correspond to different domain spaces while having overlapping sets of pixels. For instance, a set of tiles can correspond to a color space, while a second set of tiles can correspond to a luminance space where the set of tiles and the second set of tiles partially overlap with respect to the pixels of a given frame.

At block 810, the operations 800 include generating a set of control points while traversing a driving parameter of the series of frames based on a delta. Examples of operations at block 810 are described with respect to block 206 of encoder operations 200 and FIG. 4. For instance, operations at block 810 can include progressively generating control points while traversing a driving parameter (e.g., a time domain parameter, frequency domain parameter, and the like). Control points may be generated by evaluating values in the given domain space, such as luminance values, color values, frequency values and the like. The domain value may be evaluated at each frame of the series of frames, where the frames are organized sequentially with respect to the driving parameter. In response to determining the domain value between an initial frame associated with a first control point, and the domain value at a subsequent frame exceeds a delta (e.g., threshold differential), the encoder performing operations 800 can generate a second control point at the subsequent frame. This process can be iterated until the full sequence of frames for a given file is traversed.

Additionally, multiple domains can be evaluated to generate multiple sets of control points. For instance, a set of control points might correspond to luminance values, while a second set of control points can correspond to domain color space and respective color values. Thus each set of control points can correspond to different domains. Because each set of control points may evaluate thresholds in different domains, each set of control points may be independent of the other (i.e., a given frame may have a control point for a first domain, but not a second domain given the first domain exceeded a threshold differential, while the second domain did not).

At block 812, the operations 800 include storing the threaded video in a memory device, where the threaded video is sparser than the frame-based source data. Per encoding operations including at blocks 810 and 812, generation and storage of control point data in of itself can lead to significant data reductions in the generated threaded video. However, additional operations, such as reducing complexity, or color table compression and control point compression can be performed as additional operations to increase sparsity of the threaded video, as well as further compress the threaded video. FIG. 6 illustrates an example of threaded video file architecture generated per operations 800, according to some examples.

Generating and storing the threaded video includes generating sets of control points defining a thread. The thread itself, comprising an approximation based on the control points, can be stored as a part of the threaded video within the memory device. In other instances, the thread can be generated after the threaded video including the control points is transmitted or retrieved from memory. The thread can be a line, curve, spline, or other data structure providing a mathematical reconstruction and extrapolation of pixel values of a given frame, based on the set of control points. Similarly, threads can be generated for additional sets of control points, for instance based on a second or third set of control points. Thus, each domain space can have a respective set of control points generated per block 808, and respective thread generated per block 812.

In some examples, generating the thread can occur on a playback device 107. For instance, the thread can be generated by decoder 106 operations, where the decoder receives the threaded video file 103 from a local disk 104 or across a network 105. The playback device 107 can be the same device from which the frame-based video 101 was retrieved, for instance when the threaded video is retrieved from the local disk 104. In other examples, the same encoder which generated the threaded video containing the control points can further generate the threads which can similarly be stored within the threaded video file or other file. Thus, according to some examples the threads can similarly be stored to local disk 104 or transmitted over the network 105 for subsequent use on a playback device.

In some applications, because the threads are continuous values untethered from the frame-based data during the encoder operations (e.g., blocks 804-810), sampling the threads can generate tile values between frames of the original frame-based video. Such techniques thus allow for, for instance, upscaling, where input frame-based data may have a lower frame-rate (e.g., 24 fps), while the thread can be upscaled to 30 fps, 60 fps, or any other desired frames per second. Such upscaling can be performed on the same playback device 107 storing the decoder, in addition to other playback devices independent of the decoder, for instance when the encoder and decoder are stored on separate devices.

Similarly, because a first set of control points corresponding to a first tile can, and generally will, be different from a second set of control points corresponding to a second tile, the threads for each set of control points can be distinct and separately configurable for output. For instance, a first thread may have a first tile-playback rate, while a second thread may be outputted to have a second tile-playback rate different from the first tile-playback rate. Returning to the dimly lit scene example, relative invariance of tiles closer to the corners of a dark scene may have relatively fewer control points compared to tiles nearer the center of the scene which may vary in luminance and color, among other values. Relative comparisons of data and data sparsity between sets of tiles can be associated with corresponding frame rate outputs. For example, sets of tiles with fewer control points may be assigned a lower frame rate output or a variable playback rate based on the relative density of control points over a given period over the full sequence of frames.

### Example Computing System for Encoding and Decoding Threaded Video

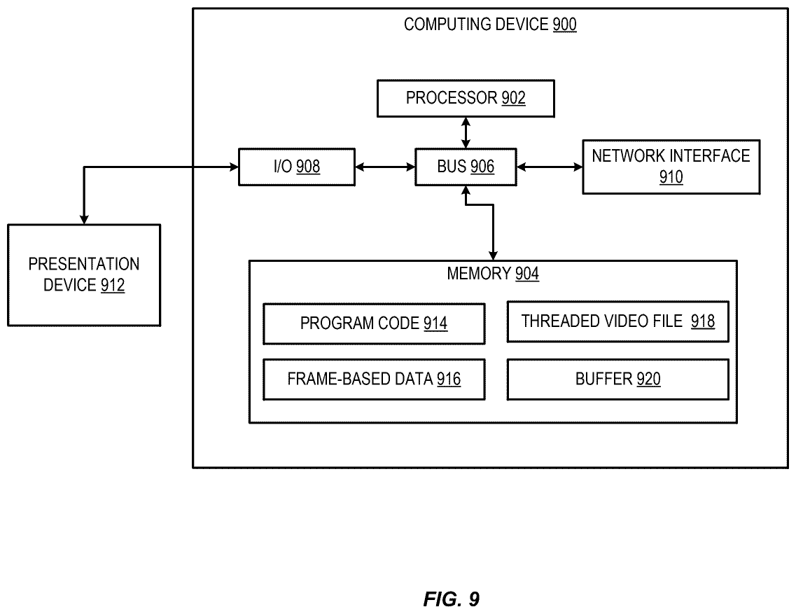

Any suitable computing system or group of computing systems can be used to perform the encoding and/or decoding operations described herein. For example, FIG. 9 shows a block diagram depicting an example of a computing device, which can be used to implement encoding operations and/or decoding operations according to certain aspects of the present disclosure. The computing device 900 can include various devices for communicating with other devices in the operating environment, as described with respect to FIG. 1. The computing device 900 can include various devices for performing one or more transformation operations described above with respect to FIGS. 1-8.

The computing device 900 can include a processor 902 that is communicatively coupled to a memory component, referred to as “memory” 904. The processor 902 executes computer-executable program code stored in the memory 904, accesses information stored in the memory 904, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 902 include a microprocessor, an application-specific integrated circuit (“ASIC”), a field-programmable gate array, or any other suitable processing device. The processor 902 can include any number of processing devices, including one. The processor 902 can include or communicate with a memory 904. The memory 904 stores program code that, when executed by the processor 902, causes the processor to perform the operations described in this disclosure.

The memory 904 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include C, C++, C#, Visual Basic, Java, Python, Perl, JavaScript, ActionScript, etc.

The computing device 900 may also include a number of external or internal devices such as input or output devices. For example, the computing device 900 is shown with an input/output interface 908 that can receive input from input devices or provide output to output devices. A bus 906 can also be included in the computing device 900. The bus 906 can communicatively couple one or more components of the computing device 900.

The computing device 900 can execute program code 914 that includes instructions executing encoding operations and/or decoding operations. The program code 914 for the encoder 102, and decoder 106, may be resident in any suitable computer-readable medium and may be executed on any suitable processing device. For example, as depicted in FIG. 9, the program code 914 for the encoder 102 and decoder 106 can reside in the memory 904 at the computing device 900 along with data processed by the program code 914 including the frame-based data 916, threaded video files 918, and various buffers 920 which may support the conversion from frame-based data 916 to the threaded video files 918.

In some aspects, the computing device 900 can include one or more output devices. One example of an output device is the network interface device 910 depicted in FIG. 9. A network interface device 910 can include any device or group of devices suitable for establishing a wired or wireless data connection to one or more data networks described herein. Non-limiting examples of the network interface device 910 include an Ethernet network adapter, a modem, etc.

Another example of an output device is the presentation device 912 depicted in FIG. 9. A presentation device 912 can include any device or group of devices suitable for providing visual, auditory, or other suitable sensory output, such as the playback device 107. Non-limiting examples of the presentation device 912 include a touchscreen, a monitor, a speaker, a separate mobile computing device, etc. In some aspects, the presentation device 912 can include a remote client-computing device that communicates with the computing device 900 using one or more data networks described herein. In other aspects, the presentation device 912 can be omitted.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification that terms such as “processing,” “computing,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computing systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Aspects of the methods disclosed herein may be performed in the operation of such computing devices. The order of the blocks presented in the examples above can be varied—for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific aspects thereof, it will be appreciated that those skilled in the art, upon attaining an understanding of the foregoing, may readily produce alterations to, variations of, and equivalents to such aspects. Any aspects or examples may be combined with any other aspects or examples. Accordingly, it should be understood that the present disclosure has been presented for purposes of example rather than limitation, and does not preclude inclusion of such modifications, variations, or additions to the present subject matter as would be readily apparent to one of ordinary skill in the art.

What is claimed is:

1. A method comprising:
receiving a frame-based video comprising a series of frames;
encoding the frame-based video into threaded video through steps comprising:
converting the frame-based video into a domain space;
generating a set of tiles, each tile of the set of tiles corresponding to a sub-space within the series of frames; and
for each tile of the set of tiles, generating a set of control points while traversing a driving parameter of the series of frames based on a delta; and
storing the threaded video in a memory device, wherein the threaded video is sparser than the frame-based video.

2. The method of claim 1, wherein the set of control points corresponds to a luminance value; and
wherein encoding the frame-based video into threaded video data further comprises, for each tile of the set of tiles, generating a second set of control points while traversing the driving parameter of the series of frames, wherein the second set of control points corresponds to a color value.

3. The method of claim 1 further comprising:
decoding the threaded video by reconstructing, for each tile, the frame-based video based on the threaded video.

4. The method of claim 3, wherein a first tile of the set of tiles has a first tile-playback rate, and a second tile of the set of tiles has a second tile-playback rate, wherein the first tile-playback rate is different than the second tile-playback rate.

5. The method of claim 3, wherein decoding the threaded video includes:
generating a thread based on the set of control points within the threaded video; and
reconstructing the frame-based video based on sampling the thread.

6. The method of claim 1, wherein generating a set of control points while traversing a driving parameter of the series of frames based on the delta comprises:
determining a luminance value or a color value for the tile at each frame of the series of frames, wherein the frames are organized sequentially with respect to the driving parameter; and
in response to determining the luminance value or color value between an initial frame associated with a first control point and a subsequent frame exceeds the delta, generating a second control point at the subsequent frame.

7. The method of claim 1, wherein the driving parameter is a time domain parameter or a frequency domain parameter.

8. A system comprising:
a memory component; and
a processing device coupled to the memory component, the processing device configured to perform operations comprising:
receiving a frame-based video comprising a series of frames;
encoding the frame-based video into threaded video through steps comprising:
converting the frame-based video into a domain space;
generating a set of tiles, each tile of the set of tiles corresponding to a sub-space within the series of frames; and
for each tile of the set of tiles, generating a set of control points while traversing a driving parameter of the series of frames based on a delta; and
storing the threaded video in a memory device.

9. The system of claim 8, wherein the set of control points correspond to a luminance value, and
wherein encoding the frame-based video into threaded video further comprises, for each tile of the set of tiles, generating a second set of control points while traversing the driving parameter of the series of frames, wherein the second set of control points corresponds to a color value.

10. The system of claim 8, the operations further comprising:
decoding the threaded video by reconstructing, for each tile, the frame-based video based on the threaded video.

11. The system of claim 10, wherein a first tile of the set of tiles has a first tile-playback rate, and a second tile of the set of tiles has a second tile-playback rate, wherein the first tile-playback rate is different than the second tile-playback rate.

12. The system of claim 10, wherein decoding the threaded video includes:
generating a thread based on the set of control points within the threaded video; and
reconstructing the frame-based video based on sampling the thread.

13. The system of claim 8, wherein generating a set of control points while traversing a driving parameter of the series of frames based on the delta comprises:
determining a luminance value or a color value for the tile at each frame of the series of frames, wherein the frames are organized sequentially with respect to the driving parameter; and
in response to determining the luminance value or color value between an initial frame associated with a first control point and a subsequent frame exceeds the delta, generating a second control point at the subsequent frame.

14. The system of claim 8, wherein the driving parameter is a time domain parameter or a frequency domain parameter.

15. A non-transitory computer readable medium storing executable instructions, which when executed by a processing device, cause the processing device to perform operations comprising:
receiving a frame-based video comprising a series of frames;
encoding the frame-based video into threaded video through steps comprising:
converting the frame-based video into a domain space;
generating a set of tiles, each tile of the set of tiles corresponding to a sub-space within the series of frames; and
for each tile of the set of tiles, generating a set of control points while traversing a driving parameter of the series of frames based on a delta; and
storing the threaded video in a memory device.

16. The non-transitory computer readable medium of claim 15, wherein the set of control points corresponds to a luminance value; and
wherein encoding the frame-based video into threaded video further comprises, for each tile of the set of tiles, generating a second set of control points while traversing the driving parameter of the series of frames, wherein the second set of control points corresponds to a color value.

17. The non-transitory computer readable medium of claim 15, the operations further comprising:
decoding the threaded video, by reconstructing, for each tile, the frame-based video based on the threaded video.

18. The non-transitory computer readable medium of claim 17, wherein a first tile of the set of tiles has a first tile-playback rate, and a second tile of the set of tiles has a second tile-playback rate, wherein the first tile-playback rate is different than the second tile-playback rate.

19. The non-transitory computer readable medium of claim 17, wherein decoding the threaded video includes:
generating a thread based on the set of control points within the threaded video; and
reconstructing the frame-based video based on sampling the thread.

20. The non-transitory computer readable medium of claim 15, wherein generating a set of control points while traversing a driving parameter of the series of frames based on the delta comprises:
determining a luminance value or a color value for the tile at each frame of the series of frames, wherein the frames are organized sequentially with respect to the driving parameter; and
in response to determining the luminance value or color value between an initial frame associated with a first control point and a subsequent frame exceeds the delta, generating a second control point at the subsequent frame.
